(19) United States
(12) Patent Application Publication
(10) Pub. No.: US 2019/0230579 A1
(43) Pub. Date: Jul. 25, 2019

(54) Method And Apparatus For Handling Cell-Specific Reference Signal Muting In Mobile Communications

(71) Applicants: Gilles CHARBIT, Cambridge (GB); Tao CHEN, Beijing (CN); MediaTek Singapore Pte. Ltd., Singapore (SG)

(72) Inventors: Gilles Charbit, Cambridge (GB); Tao Chen, Beijing (CN)

(21) Appl. No.: 16/330,665

(22) PCT Filed: May 16, 2018
(86) PCT No.: PCT/CN2018/087060

§ 371 Date: Mar. 5, 2019

Related U.S. Application Data
(60) Provisional application No. 62/507,282, filed on May 17, 2017.
(60) Provisional application No. 62/508,459, filed on May 19, 2017.

(51) Int. Cl. H04W 48/12; H04W 28/20; H04L 5/00; H04W 48/06; H04W 72/12

(52) U.S. Cl. CPC H04W 48/12; H04W 28/20; H04W 72/1257; H04W 48/06; H04L 5/005

(57) ABSTRACT

Various solutions for handling cell-specific reference signal muting with respect to user equipment and network apparatus in mobile communications are described. An apparatus may receive a bandwidth configuration via a system information block (SIB). The apparatus may receive a reference signal (RS) in a bandwidth indicated by the bandwidth configuration. The apparatus may perform downlink synchronization in the bandwidth. The apparatus may perform a downlink reception or an uplink transmission in the bandwidth.

### CROSS REFERENCE TO RELATED PATENT APPLICATION(S)

The present disclosure is part of U.S. national stage of international patent application PCT/CN2018/087060, filed on 16 May 2018, which claims the priority benefit of U.S. Provisional Patent Application Nos. 62/507,282 and 62/508,459, filed on 17 May 2017 and 19 May 2017, respectively. Contents of above-listed applications are herein incorporated by reference in their entirety.

### TECHNICAL FIELD

The present disclosure is generally related to mobile communications and, more particularly, to handling cell-specific reference signal muting with respect to user equipment and network apparatus in mobile communications.

### BACKGROUND

Unless otherwise indicated herein, approaches described in this section are not prior art to the claims listed below and are not admitted as prior art by inclusion in this section.

In a wireless communication system such as Long-Term Evolution (LTE), some reference signals may be transmitted or broadcasted by the network nodes of the communication system. The reference signals may comprise a cell-specific reference signal (CRS) or other reference signals. The reference signal may be received by the user equipment (UE) and may be used for performing channel estimation, downlink synchronization or radio resource measurement. The network node may determine a system bandwidth for transmitting the CRS and configure the system bandwidth for the UE to receive the CRS. However, if the system bandwidth for transmitting the CRS occupies a large frequency span, the CRS transmissions among nodes may cause inter-cell interferences and waste radio resources. Accordingly, the CRS muting or CRS mitigation is proposed to reduce the inter-cell interferences and improve spectrum efficiency.

The CRS muting or CRS mitigation may affect the channel estimation or downlink synchronization needed to be performed by the UE. The downlink or uplink transmission following the channel estimation or downlink synchronization may also be affected. Accordingly, how to reduce inter-cell interferences without degrading the UE's transmission may be important for improving system performance. It is needed to proper design the CRS transmission and muting in developing the wireless communication system.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to handling CRS muting with respect to user equipment and network apparatus in mobile communications.

In one aspect, a method may involve an apparatus receiving a first bandwidth configuration via a system information block (SIB). The method may also involve the apparatus receiving a reference signal (RS) in a first bandwidth indicated by the first bandwidth configuration. The method may further involve the apparatus performing downlink synchronization in the first bandwidth. The method may further involve the apparatus performing a downlink reception or a first uplink transmission in the first bandwidth.

In one aspect, an apparatus may comprise a transceiver capable of wirelessly communicating with a plurality of nodes of a wireless network. The apparatus may also comprise a processor communicatively coupled to the transceiver. The processor may be capable of receiving a first bandwidth configuration via a system information block (SIB). The processor may also be capable of receiving a reference signal (RS) in a first bandwidth indicated by the first bandwidth configuration. The processor may further be capable of performing downlink synchronization in the first bandwidth. The processor may further be capable of performing a downlink reception or a first uplink transmission in the first bandwidth.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to handling CRS muting with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

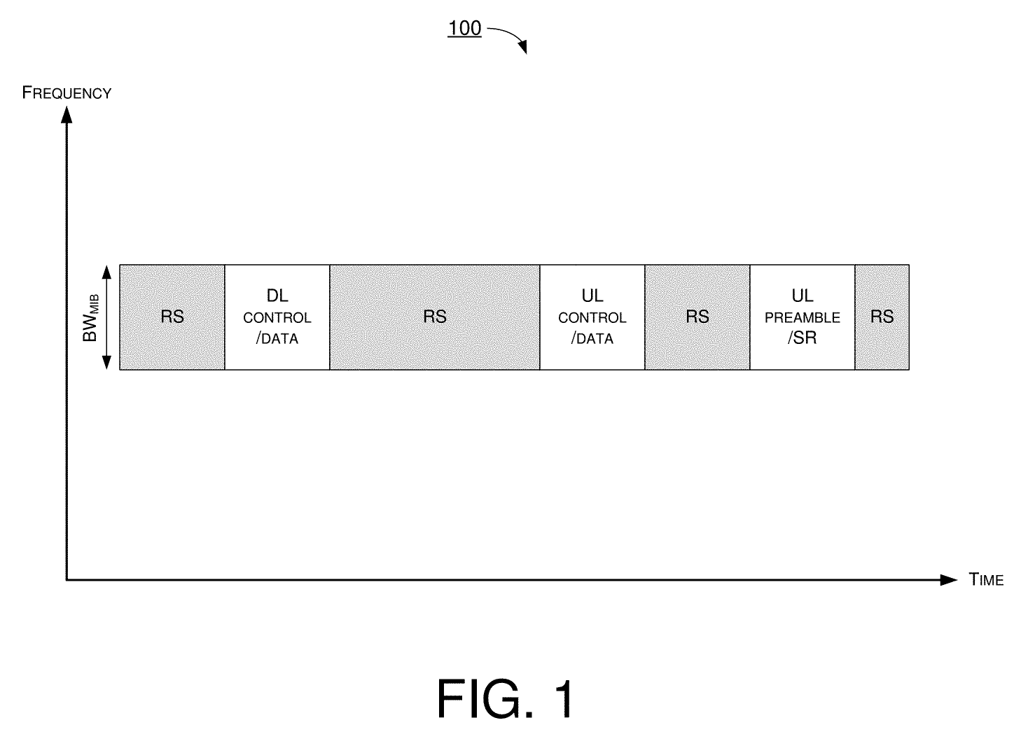

FIG. 1 illustrates an example scenario 100 under schemes in accordance with implementations of the present disclosure. Scenario 100 involves a UE and a network apparatus, which may be a part of a wireless communication network (e.g., an LTE network, an LTE-Advanced network, an LTE-Advanced Pro network, a 5G network, an NR network, an IoT network or an NB-IoT network). The network apparatus may be configured to configure a system bandwidth for the UE to perform downlink and uplink transmissions. Specifically, the UE may be configured to receive a master information block (MIB) from the network apparatus. The UE may receive a bandwidth configuration via the MIB. The bandwidth configuration may indicate a bandwidth (e.g., BW_{MIB}). The UE may be configured to receive a reference signal (RS) in the bandwidth indicated by the bandwidth configuration. The RS may comprise a cell-specific reference signal (CRS) or other reference signals. The UE may be configured to use the RS in the bandwidth to perform the downlink synchronization or the channel quality estimation/measurement. The UE may then perform downlink receptions or uplink transmissions after the downlink synchronization.

However, too much CRS transmissions among cells may cause inter-cell interferences and waste radio resources. Accordingly, the CRS muting or CRS mitigation is proposed to reduce the inter-cell interferences and improve spectrum efficiency. In CRS muting, the network apparatus may transmit the CRS in a narrower bandwidth (e.g., 1.4 MHz, 3 MHz, etc.). The network apparatus may configure a reduced bandwidth for the UE to receive the CRS. The reduced bandwidth (e.g., BW_{CRSmuting}) may be greater than mid 6 physical resource block (PRB) and less than the maximum bandwidth of a carrier. The network apparatus may mute or not transmit the CRS outside the reduced bandwidth.

The network apparatus may adaptively adjust the bandwidth (e.g., BW_{MIB}) for the CRS transmission according to the network load. For example, in the low-load scenario, the number of the UEs in connected mode or the required data rates is low. The network apparatus may configure a smaller bandwidth (e.g., 1.4 MHz). In the high-load scenario, the number of the UEs in connected mode or the required data rates is high. The network apparatus may configure a larger bandwidth (e.g., 20 MHz). The network apparatus may change the bandwidth (e.g., BW_{MIB}) in the system information (SI) acquisition procedure.

Specifically, the UE may be notified of change of system information via a broadcast control channel (BCCH) modification notification on a paging channel (PCH). The paging message may be used to inform the UE in the radio resource control (RRC) connected mode or the RRC idle mode about a system information change. The UE may apply the SI acquisition procedure upon receiving a notification indicating that the system information has changed. For example, system information block type 1 (SIB 1) may comprises a value tag (e.g., systemInfoValueTag) to indicate whether a change has occurred in the SI messages. The UE may be configured to receive the BCCH modification notification via the paging message at BCCH modification period (n) and read the updated information (e.g., new bandwidth configuration) at next BCCH modification period (n+1). The BCCH modification period may be determined as modificationPeriodCoeff*default discontinuous reception (DRX) cycle configuration. For example, the minimum BCCH modification period may be determined as minimum modificationPeriodCoeff*minimum default DRX cycle configuration=2*32 radio frames=640 millisecond.

Accordingly, the network apparatus and the UE may use the adaptive bandwidth to transmit/receive the mitigated or restricted RS transmission. The mitigated or restricted RS transmission may help to reduce the inter-cell interferences and improve overall system performance compared to the always-on full spectrum RS transmission.

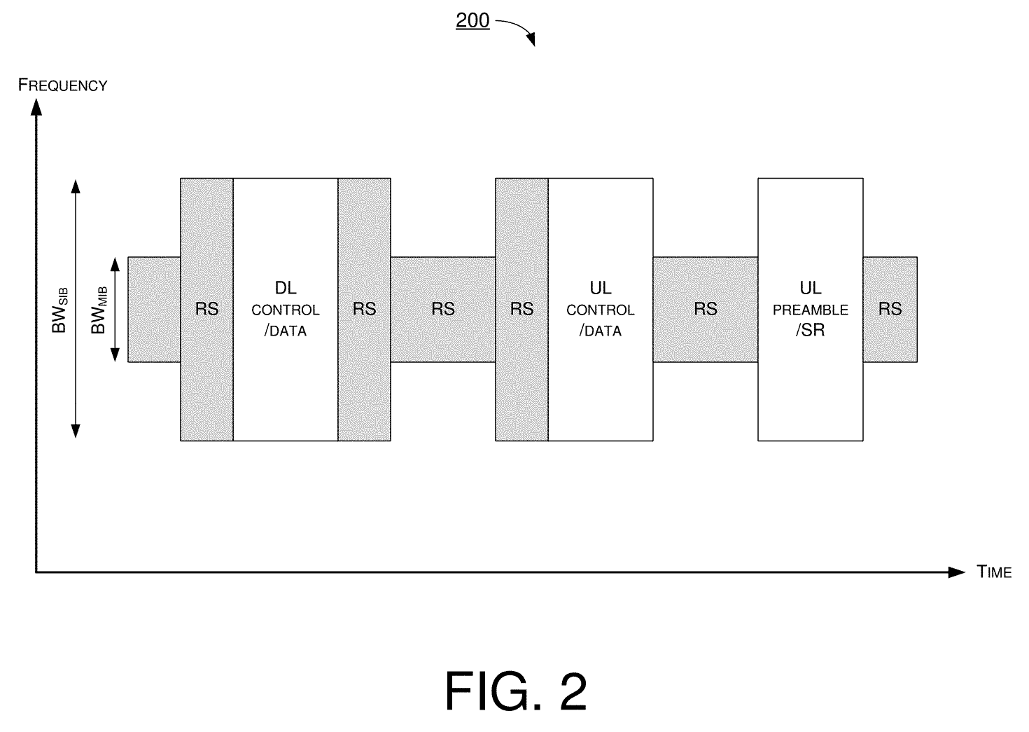

FIG. 2 illustrates an example scenario 200 under schemes in accordance with implementations of the present disclosure. Scenario 200 involves a UE and a network apparatus, which may be a part of a wireless communication network (e.g., an LTE network, an LTE-Advanced network, an LTE-Advanced Pro network, a 5G network, an NR network, an IoT network or an NB-IoT network). Similarly, the network apparatus and the UE may use a narrow bandwidth (e.g., 1.4 MHz) for the CRS muting or CRS mitigation. For example, the UE may be configured to receive a MIB from the network apparatus. The UE may receive a second bandwidth configuration via the MIB. The second bandwidth configuration may indicate a second bandwidth (e.g., BW_{MIB}) which may be a narrow bandwidth (e.g., 1.4 MHz). The UE may be configured to receive the RS in the second bandwidth indicated by the second bandwidth configuration. The RS may comprise the CRS or other reference signals. The second bandwidth configuration may be used for the CRS muting or CRS mitigation.

The UE may further be configured to receive a system information block (SIB) from the network apparatus. The UE may receive a first bandwidth configuration via the SIB. The SIB may be a new SIB or an existing SIB (e.g., SIB 3 or SIB 5). The first bandwidth configuration may be indicated by a new field or an existing field (e.g., allowedMeasBandwidth on SIB 3 or SIB 5) of the SIB. The first bandwidth configuration may indicate a first bandwidth (e.g., BW_{SIB}) which may be a large bandwidth (e.g., 20 MHz). The first bandwidth (e.g., BW_{SIB}) is greater than the second bandwidth (e.g., BW_{MIB}).

After receiving the first bandwidth configuration, the UE may be configured to override the second bandwidth configuration by the first bandwidth configuration. The UE may be configured to receive the RS in the first bandwidth indicated by the first bandwidth configuration. The RS may comprise the CRS or other reference signals. The UE may be configured to use the RS in the first bandwidth to perform the downlink synchronization, the channel quality estimation/measurement or the radio resource management (RRM) measurement. The UE may then perform downlink receptions or first uplink transmissions in the first bandwidth after the downlink synchronization.

The downlink reception may comprise the downlink control reception or the downlink data reception. The first uplink transmission may comprise at least one of the uplink granted transmission, the uplink control transmission or the uplink data transmission. When the downlink data or uplink data is transmitted in high data rate or modulated with high order modulation, it may be better to use large CRS bandwidth to perform channel estimation for the downlink reception or uplink transmission. Accordingly, although the second bandwidth (e.g., BW_{MIB}) is configured for reducing the inter-cell interference, the UE may still be able to use the first bandwidth (e.g., BW_{SIB}) to perform channel estimation or downlink synchronization for the downlink reception or uplink transmission.

The UE may further be configured to use the RS in the second bandwidth (e.g., BW_{MIB}) to perform the downlink synchronization, the channel quality estimation/measurement or the RRM measurement which is used for second uplink transmissions. The second uplink transmission may comprise at least one of the uncertain uplink transmission, the preamble transmission or the service request (SR) transmission. The UE may then perform the second uplink transmission in the first bandwidth (e.g., BW_{SIB}) after the downlink synchronization. In other words, the UE may still use the second bandwidth (e.g., BW_{MIB}) for the downlink synchronization before the preamble/SR transmission.

Similarly, the UE may be notified of change of system information via a BCCH modification notification on a PCH. The UE may be configured to receive the BCCH modification notification via the paging message at BCCH modification period (n) and read the updated information (e.g., new bandwidth configuration) at next BCCH modification period (n+1). In order to ensure the UE may receive the changed SIB or MIB correctly for the new bandwidth configuration, the large bandwidth CRS or at least the same bandwidth of the CRS in BCCH modification period (n+1) as BCCH modification period (n) may be applied in a plurality of consecutive sub-frames just before acquisition of the new bandwidth configuration carried in the corresponding SIB. This may ensure the proper synchronization for the SIB acquisition.

### Illustrative Implementations

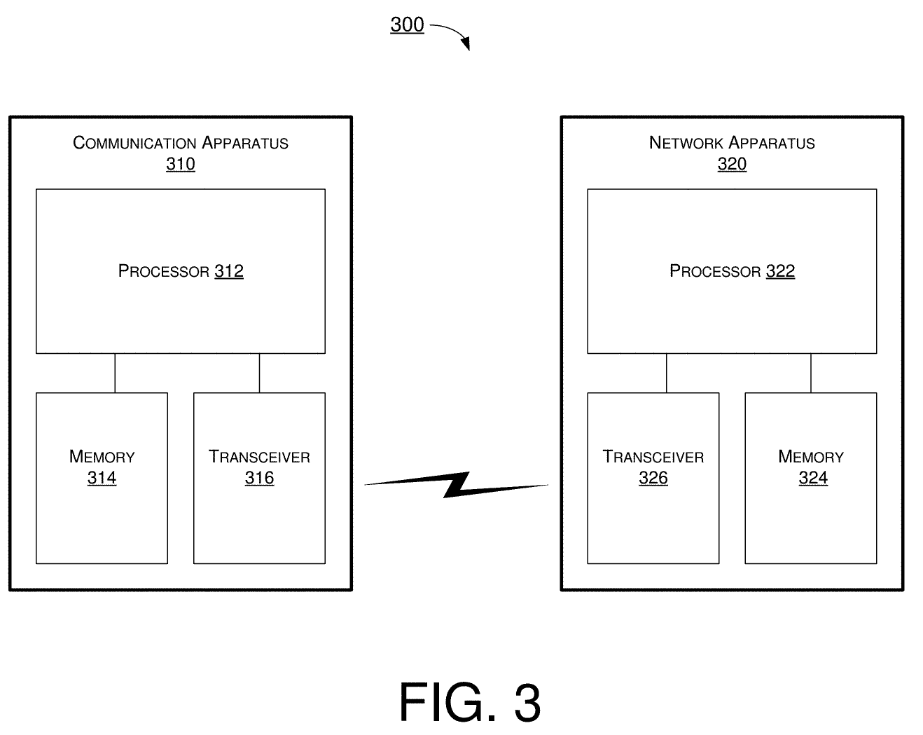

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to handling CRS muting with respect to user equipment and network apparatus in wireless communications, including scenarios 100 and 200 described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to receive, via transceiver 316, a MIB from network apparatus 320. Processor 312 may receive a second bandwidth configuration via the MIB. The second bandwidth configuration may indicate a second bandwidth (e.g., BW_{MIB}) which may be a narrow bandwidth (e.g., 1.4 MHz). Processor 312 may be configured to receive the RS in the second bandwidth indicated by the second bandwidth configuration. The RS may comprise the CRS or other reference signals. Processor 312 may use the second bandwidth configuration for the CRS muting and/or CRS mitigation.

In some implementations, processor 312 may further be configured to receive a SIB from network apparatus 320. Processor 312 may receive a first bandwidth configuration via the SIB. Processor 312 may receive the first bandwidth configuration via a new SIB or an existing SIB (e.g., SIB 3 or SIB 5). Processor 312 may read the first bandwidth configuration in a new field or an existing field (e.g., allowedMeasBandwidth on SIB 3 or SIB 5) of the SIB. The first bandwidth configuration may indicate a first bandwidth (e.g., BW_{SIB}) which may be a large bandwidth (e.g., 20 MHz). The first bandwidth (e.g., BW_{SIB}) is greater than the second bandwidth (e.g., BW_{MIB}).

In some implementations, after receiving the first bandwidth configuration, processor 312 may be configured to override the second bandwidth configuration by the first bandwidth configuration. Processor 312 may be configured to receive the RS in the first bandwidth indicated by the first bandwidth configuration. The RS may comprise the CRS or other reference signals. Processor 312 may be configured to use the RS in the first bandwidth to perform the downlink synchronization, the channel quality estimation/measurement or the RRM measurement. Processor 312 may then perform downlink receptions or first uplink transmissions in the first bandwidth after the downlink synchronization.

In some implementations, the downlink reception may comprise the downlink control reception or the downlink data reception. The first uplink transmission may comprise at least one of the uplink granted transmission, the uplink control transmission or the uplink data transmission.

In some implementations, processor 312 may further be configured to use the RS in the second bandwidth (e.g., BW_{MIB}) to perform the downlink synchronization, the channel quality estimation/measurement or the RRM measurement which is used for second uplink transmissions. The second uplink transmission may comprise at least one of the uncertain uplink transmission, the preamble transmission or the service request (SR) transmission. Processor 312 may then perform the second uplink transmission in the first bandwidth (e.g., BW_{SIB}) after the downlink synchronization. In other words, processor 312 may still use the second bandwidth (e.g., BW_{MIB}) for the downlink synchronization before the preamble/SR transmission.

In some implementations, processor 312 may be notified of change of system information via a BCCH modification notification on a PCH. Processor 312 may be configured to receive the BCCH modification notification via the paging message at BCCH modification period (n) and read the updated information (e.g., new bandwidth configuration) at next BCCH modification period (n+1). In order to ensure processor 312 may receive the changed SIB or MIB correctly for the new bandwidth configuration, the large bandwidth CRS or at least the same bandwidth of the CRS in BCCH modification period (n+1) as BCCH modification period (n) may be applied in a plurality of consecutive sub-frames just before acquisition of the new bandwidth configuration carried in the corresponding SIB. This may ensure the proper synchronization for the SIB acquisition.

### Illustrative Processes

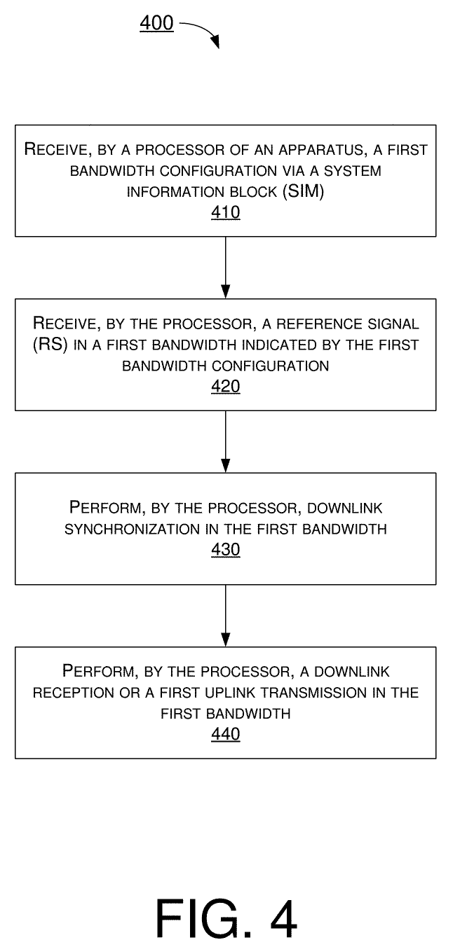

FIG. 4 illustrates an example process 400 in accordance with an implementation of the present disclosure. Process 400 may be an example implementation of scenarios 210 and 230, whether partially or completely, with respect to handling CRS muting in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 receiving a first bandwidth configuration via a system information block (SIB). Process 400 may proceed from 410 to 420.

At 420, process 400 may involve processor 312 receiving a reference signal (RS) in a first bandwidth indicated by the first bandwidth configuration. Process 400 may proceed from 420 to 430.

At 430, process 400 may involve processor 312 performing downlink synchronization in the first bandwidth. Process 400 may proceed from 430 to 440.

At 440, process 400 may involve processor 312 performing a downlink reception or a first uplink transmission in the first bandwidth.

In some implementations, process 400 may involve processor 312 receiving a second bandwidth configuration via a master information block (MIB). Process 400 may also involve processor 312 receiving the RS in a second bandwidth indicated by the second bandwidth configuration. Process 400 may further involve processor 312 performing downlink synchronization in the second bandwidth. Process 400 may further involve processor 312 performing, by the processor, a second uplink transmission in the first bandwidth.

In some implementations, the first uplink transmission may comprise at least one of an uplink granted transmission, an uplink control transmission or an uplink data transmission.

In some implementations, the second uplink transmission may comprise at least one of an uncertain uplink transmission, a preamble transmission or a service request (SR) transmission.

In some implementations, the first bandwidth may be greater than the second bandwidth.

In some implementations, process 400 may involve processor 312 overriding the second bandwidth configuration by the first bandwidth configuration for the downlink reception or the first uplink transmission.

In some implementations, the SIB may comprise a new SIB or an existing SIB. The first bandwidth may be indicated by a new field or an existing field of the SIB.

In some implementations, the RS may comprise a cell-specific reference signal (CRS). The second bandwidth configuration may be used for CRS muting. For instance, process 400 may involve processor 312 performing CRS muting using the second bandwidth configuration.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a first bandwidth configuration via a system information block (SIB);
receiving, by the processor, a reference signal (RS) in a first bandwidth indicated by the first bandwidth configuration;
performing, by the processor, downlink synchronization in the first bandwidth; and
performing, by the processor, a downlink reception or a first uplink transmission in the first bandwidth.

2. The method of claim 1, further comprising:
receiving, by the processor, a second bandwidth configuration via a master information block (MIB);
receiving, by the processor, the RS in a second bandwidth indicated by the second bandwidth configuration;
performing, by the processor, downlink synchronization in the second bandwidth; and
performing, by the processor, a second uplink transmission in the first bandwidth.

3. The method of claim 1, wherein the first uplink transmission comprises at least one of an uplink granted transmission, an uplink control transmission or an uplink data transmission.

4. The method of claim 2, wherein the second uplink transmission comprises at least one of an uncertain uplink transmission, a preamble transmission or a service request (SR) transmission.

5. The method of claim 2, wherein the first bandwidth is greater than the second bandwidth.

6. The method of claim 2, further comprising:
overriding, by the processor, the second bandwidth configuration by the first bandwidth configuration for the downlink reception or the first uplink transmission.

7. The method of claim 1, wherein the SIB comprises a new SIB or an existing SIB.

8. The method of claim 1, wherein the first bandwidth is indicated by a new field or an existing field of the SIB.

9. The method of claim 1, wherein the RS comprises a cell-specific reference signal (CRS).

10. The method of claim 9, further comprising:
performing, by the processor, CRS muting using the second bandwidth configuration.

11. An apparatus, comprising:
a transceiver capable of wirelessly communicating with a plurality of nodes of a wireless network; and
a processor communicatively coupled to the transceiver, the processor capable of:
receiving, via the transceiver, a first bandwidth configuration via a system information block (SIB);
receiving, via the transceiver, a reference signal (RS) in a first bandwidth indicated by the first bandwidth configuration;
performing downlink synchronization in the first bandwidth; and
performing a downlink reception or a first uplink transmission in the first bandwidth.

12. The apparatus of claim 11, wherein the processor is further capable of:
receiving, via the transceiver, a second bandwidth configuration via a master information block (MIB);
receiving, via the transceiver, the RS in a second bandwidth indicated by the second bandwidth configuration;
performing downlink synchronization in the second bandwidth; and
performing a second uplink transmission in the first bandwidth.

13. The apparatus of claim 11, wherein the first uplink transmission comprises at least one of an uplink granted transmission, an uplink control transmission or an uplink data transmission.

14. The apparatus of claim 12, wherein the second uplink transmission comprises at least one of an uncertain uplink transmission, a preamble transmission or a service request (SR) transmission.

15. The apparatus of claim 12, wherein the first bandwidth is greater than the second bandwidth.

16. The apparatus of claim 12, wherein the processor is further capable of:
overriding the second bandwidth configuration by the first bandwidth configuration for the downlink reception or the first uplink transmission.

17. The apparatus of claim 11, wherein the SIB comprises a new SIB or an existing SIB.

18. The apparatus of claim 11, wherein the first bandwidth is indicated by a new field or an existing field of the SIB.

19. The apparatus of claim 11, wherein the RS comprises a cell-specific reference signal (CRS).

20. The apparatus of claim 19, wherein the processor is further capable of:
performing CRS muting using the second bandwidth configuration.
